(19) United States
(12) Patent Application Publication
(10) Pub. No.: US 2015/0284283 A1
(43) Pub. Date: Oct. 8, 2015

(54) METHOD FOR GLASS TEMPERING USING MICROWAVE RADIATION

(71) Applicant: Gyrotron Technology, Inc., Bensalem, PA (US)

(72) Inventors: Vladislav SKLYAREVICH, Bensalem, PA (US); Mykhaylo SHEVELEV, Bensalem, PA (US)

(73) Assignee: GYROTRON TECHNOLOGY, INC., Bensalem, PA (US)

(21) Appl. No.: 14/561,958

(22) Filed: Dec. 5, 2014

Related U.S. Application Data
(60) Provisional application No. 61/973,928, filed on Apr. 2, 2014.

(51) Int. Cl. C03B 27/00

(52) U.S. Cl. CPC C03B 27/00

(57) ABSTRACT

A method of thermally tempering a glass sheet. The method includes preheating the glass sheet to a temperature higher a strain point of the glass sheet and lower than a softening point of the glass sheet, exposing the glass sheet to a beam of penetrating microwave radiation in order to heat the mid-plane of the glass sheet to a temperature that is above the softening point while simultaneously keeping a surface of the glass sheet at a temperature that is below the softening point, and quenching the glass sheet so that the temperature of the mid-plane and the surface of the glass sheet fall below the strain point, respectively.

This application claims the benefit of U.S. Provisional Patent Application No. 61/973,928 filed on Apr. 2, 2014, the entire disclosure of which is hereby incorporated by reference.

### BACKGROUND

1. Field

Methods consistent with exemplary embodiments related to the thermal tempering of any type of glass or glass-like materials, preferably of a sheet of glass.

2. Description of Related Art

Glass sheets may be thermally tempered to increase the strength or breaking resistance of the glass. Traditionally, thermal tempering performed by heating glass sheets to near the softening point of the glass, which is typically in the range of 1160° F. to 1300° F. 627° C. to 704° C.) and then rapidly cooling the surface of the glass. As a result of the rapid cooling of the surface of the glass, the mid-plane of the glass cools at a slower rate due low glass thermal conductivity. This differential cooling results in a compressive stress in the surface regions of the glass. This compressive stress is balanced by a tension stress in the mid-plane of the glass.

The above-described process, however, suffers from several disadvantages. First, fully tempered glass that has been made in a horizontal furnace may contain surface distortions. Specifically, while the glass surface is heated to (or near) the softening point, the glass is moved by hard conveyer rollers that create marks on the surface of the glass. Second, the high temperatures cause the glass to become less flat, i.e., the glass becomes bowed.

Another disadvantage is that the temper level of the glass is limited because, as described above, the temper level depends the differential cooling between the surfaces and the mid-plane of the glass. Furthermore, increasing the glass temperature leads to even larger marks and even greater bowing. On the other hand, increasing the cooling rate is limited because higher air pressure is more likely to cause the hot glass to break.

Moreover, almost every thermal tempering process relies on heating the glass with infrared energy. In a case where the glass sheet has a low emissivity (low-e) coating, this infrared energy is not only reflected but also absorbed by the low-e coating causing the coating temperature to undesirably increase. In addition, those skilled in the art understand that low-e coatings are very sensitive to overheating. As a result, it is quite difficult to thermally temper a glass sheet that has a low-e coating without damaging the glass, the low-e coating, or both.

One possible approach is to address these issues is to improve the tempering equipment, in particular the quench nozzles. These approaches only minimally improve the cooling ability of the quenches. Nevertheless, the other problems mentioned above, such as those associated with roller marks and low-e coating are not solved by improving the tempering equipment.

Another possible approach is to minimize the rollers marks is to simply reduce the conveyer speed. However, this approach is less than desirable because the industry prefers highly productive processes and equipment. Also, even though reducing the conveyer speed reduces the roller marks, it does not eliminate the roller marks, the glass still bows, and the low-e issues still remain.

Yet another possible approach for achieving a higher tempered stress is to utilize a multistage tempering process that includes using radio frequency (RF) radiation. However, this type of approach does not significantly increase the tempering strength and also requires equipment that is more complicated and larger. As a result, not only is more floor space required, but also the energy consumption and cost of the equipment increases. Also, even though using a multistage tempering process slightly increases the tempering strength, this approach does not solve the problems associated with the roller marks, the bowing, or the low-e coated glass.

The present inventors are not aware of any method that simultaneously increases the tempering stress, eliminates roller marks and overall bow, as well as, allows effectively tempering glass with low-e coating. Thus, there is a clear need in the art for a method that substantially improves the qualities of tempered glass.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not assume to have been recognized in any prior art on the basis of this section, unless otherwise indicated.

### SUMMARY

One or more exemplary embodiments may overcome the above disadvantages and other disadvantages not described above. However, it is understood that one or more exemplary embodiment are not required to overcome the disadvantages described above, and may not overcome any of the problems described above.

According to the present disclosure, a method is provided for the thermally tempering glass sheet, comprising preheating glass sheet to temperature higher than glass strain point but lower than softening point. After that the glass sheet is exposed to a beam of penetrating microwave radiation where the radiation having an effective frequency and sufficient power density to further primary heat glass sheet mid-plane whereby a sufficient temperature distribution across the glass sheet to allow tempering of the glass sheet after quenching is obtained. The beam is directed to both or one of the glass surfaces and can be scanned over them. In case of tempering low-e coated glass it is exposing to beam from not coated surface.

The wavelengths of the beam are selected to provide radiation penetration depth equal from 0.5 to 5 glass sheet thicknesses. For most glass kinds this request can be meet if the radiation frequency will be between about 10 GHz to about 200 GHz. The most preferable microwave radiation frequency is that corresponds to a wavelength in the glass of about two glass thicknesses of the glass sheet being heated. This provides sharper temperature distribution across the glass sheet thickness.

The power density of the radiation may be selected that is greater than a predetermined threshold and great adequate cause the heating mid-plane fast enough to create a sufficient temperature distribution across the glass sheet to allow tempering of the glass sheet after quenching

This, the exemplary methods described herein use a specialized generator, such as a gyrotron, to generate a beam of microwave radiation that is in the above-mentioned range of frequencies and powers/power densities.

An uncoated and coated glass articles tempered in accordance with the present disclosure have high temper stress and high optical quality. It is flat and does not have rollers marks, as well as damage of the coating. In addition, manufacturing costs are reduced and the production rate is increased.

This glass may be used in the production of architectural windows glass and doors, tables, refrigerator trays, glazing for vehicles, various types of plates, solar panels, and the like.

### BRIEF DESCRIPTION OF THE DRAWINGS

The above and/or other aspects will be more apparent by describing certain exemplary embodiments with reference to the accompanying drawings, in which:

FIG. 1 is a flowchart of a method according to the present disclosure;

FIG. 2 is a time-based temperature graph of a glass sheet during an exemplary thermal tempering, according to the present disclosure;

FIG. 3 illustrates the microwave power/temperature profiles inside a glass sheet when it is irradiated by microwave radiation with a preferable frequency that corresponds to a wavelength in the glass of about two glass thicknesses of the glass sheet being heated;

FIG. 4 illustrates the microwave low-e coated power/temperature profiles inside a glass sheet when low-e coating is used as a reflector and the microwave radiation frequency corresponds to a wavelength in the glass of about two times the thickness of the glass sheet being heated; and

FIG. 5 illustrates an example of the radiation set up.

### DETAILED DESCRIPTION

Certain exemplary embodiments of the present inventive concept will now be described in greater detail with reference to the accompanying drawings. Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

The following detailed description is provided to assist the reader in gaining a comprehensive understanding of the methods, apparatuses, and/or systems described herein. However, various changes, modifications, and equivalents of the methods, apparatuses and/or systems described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

As provided in greater detail below, the present inventors have discovered a method for thermally tempering a glass sheet while the glass surfaces remain hard enough to prevent roller marks from occurring. That is, the mid-plane of the glass sheet is heated to above the softening point while the surfaces of the glass are below the softening point. This high temperature differential between the surfaces and the mid-plane substantially improve the qualities of tempered glass. In addition, in some embodiments, the glass sheet is heated with microwave radiation. In a case where the glass sheet has a low-e coating, the low-e coating reflects the microwave radiation. In other words, the low-e coating does not absorb the microwave radiation. As a result, when compared to the related art, it much easier to control the thermal tempering of a low-e coated glass sheet thereby leading to a higher quality product and a greater yield. The exemplary methods for thermally tempering a glass sheet described herein are different from previous attempts to thermally temper glass using electromagnetic radiation in that the exemplary methods described herein permit a glass article to be thermally tempered without rollers marks, bow, and to higher stress level.

As detailed below, one or more exemplary methods of the present disclosure applies microwave radiation with i) a wavelength (frequency) that is commensurable to the thickness of the glass thickness, and ii) a sufficient power density. The power density of the microwave radiation should be sufficiently high to produce a temperature difference between the mid-plane and the surfaces of the glass, overcoming thermo conductive heat flux created by the temperature difference, as well as, natural heat loss. The combination of the microwave radiation wavelength and power density allows the temperature of the surfaces of the glass be less than the softening point while simultaneously allowing the temperature of the mid-plane of the glass to be above the softening point. As a result, the mid-plane of the glass is heated fast enough to create a sufficient temperature distribution across the glass sheet thereby allowing tempering of the glass sheet after quenching. Since the surfaces of the glass are colder and, therefore, stronger when compared to the related art, the features of the present disclosure prevent roller marks from occurring and also prevent overall glass bending. In addition, because the glass is stronger relative to the related art glass, the quench air pressure can be increased in order to achieve a higher tempering level. The lower glass surface temperature also results increases the optical quality of the glass and requires less energy for preheating and quenching. Moreover, in a case where the glass sheet has a low-e coating, the microwave frequency does not undesirably overheat the glass. In contrast, since the related art uses infrared energy to heat the glass, the low-e coating undesirably absorbs the infrared energy which causes the coating to overheat undesirably.

According to the present disclosure, the frequency of the microwave radiation and the power density of the applied electromagnetic radiation are parameters that are determined for each type of glass to be processed. These parameters and how they are chosen are described below for an exemplary embodiment of the present disclosure in which a glass article is initially preheated to a temperature that is higher than a strain point of the glass and lower than a softening point of the glass.

As used herein the term “glass” means any type of glass or glass-like material the density of which changes suddenly with temperature. The exemplary methods described herein are generally applicable to the treatment of any type of glass. These treatments include but are not limited to glass sheets, such as those employed in the production architectural windows glass and doors, tables, refrigerator trays, glazing for vehicles, various types of plates, display glass for mobile devices and tablets, and the like.

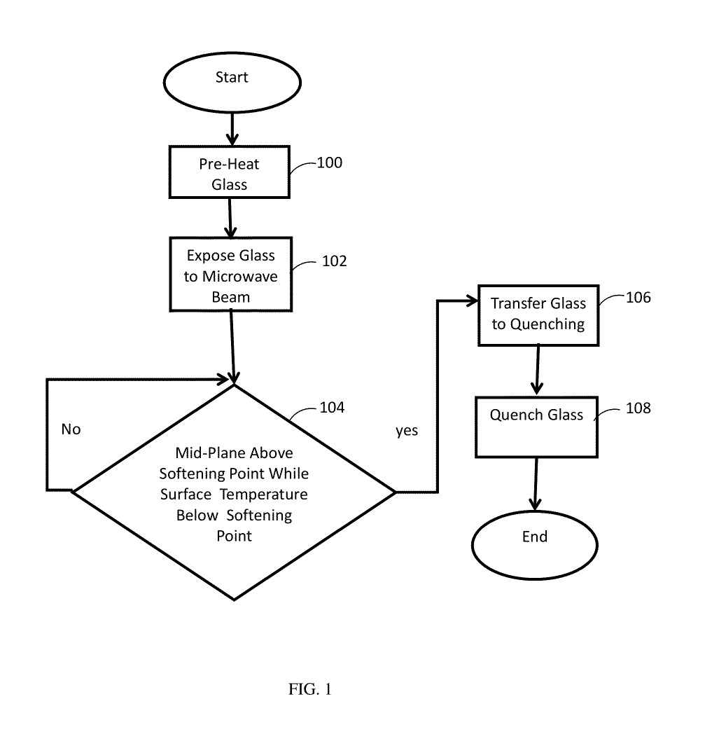

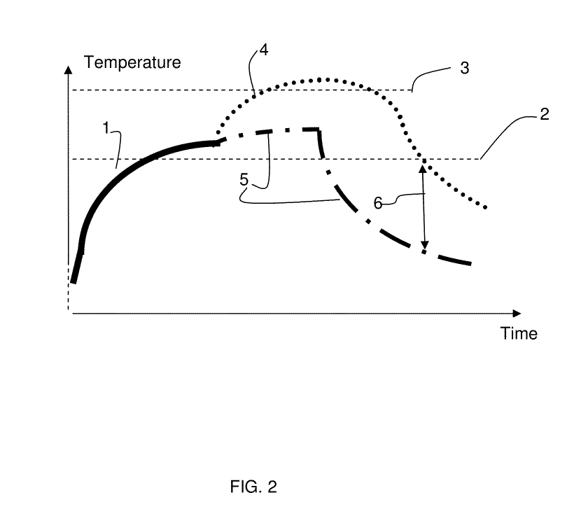

Referring to FIGS. 1 and 2, which respectively show a flowchart and a time-based temperature graph of the glass sheet during the thermal tempering according to an exemplary embodiment. Initially at 100, the glass sheet is preheated in oven to a temperature 1 higher than the strain point 2 but lower than the softening point 3. After that at 102, the beam of a microwave radiation is applied to the glass sheet at the end of preheating cycle in such a manner that the temperature of the mid-plane 4 continues to increase while the temperature of the surface 5 remains close to the initial preheating temperature. This selective heating is achieved by selecting the penetration depth of the microwave radiation to be around 0.5-5 times the thickness of the glass sheet.

For example, if the thickness of the glass sheet is up to 15 mm, the frequency should be selected in between 10 GHz to 200 GHz for common glass compositions. For thin glass, the frequency should be in a higher range of the band and on the contrary for thicker glass the frequency is in a lower range of the band. Said differently, as the thickness of the glass increases, the frequency of the microwave radiation should be decreased. As the thickness of the glass decreases, the frequency of the microwave radiation should increase. That is, the frequency of the microwave radiation is selected to be inversely proportional to the thickness of the glass.

The power density of the microwave radiation is selected to overcome temperature equalizing across the thickness of the glass due to thermal conductivity. It is clear that this microwave heating process should be short. For common glass thickness this time is in the order of a few seconds. Of course, those skilled in the art having read this specification will understand that as the thickness of the glass changes so does the duration of the microwave heating process.

The present inventors recognized that the required power density is in the order of dozens or even hundred watts per square centimeter depending on the glass thickness. To achieve such relatively high power density, the present disclosure utilizes microwave energy in the form of a powerful beam. Such a beam can be produced by, for example, a gyrotron. A gyrotron is a powerful microwave generator. Using microwave optical system consisting of metal mirrors this beam can be easily transferred to any required shape and size.

Next at 104 it is determined whether the mid-plane temperature 4 is greater than the softening point while the surface temperature 5 is below the softening point 3, if so (yes at 104) then the glass sheet is transferred to a quench 106. Lastly, at 108 the glass sheet is quenched so that both mid-plane temperature 4 and the surface temperature 5 drop below the strain point 2. The temperature difference 6 provides a tempering stress, and depends on the preheating temperature, glass thickness and powers of the microwave and quenching. For example, to achieve full tempering of 3 mm glass the temperature difference 6 needed is about 110° C. and the whole glass sheet needs to be preheated to about 650° C. In the related art, this makes the glass soft and results in marks on the glass from the rollers. Further increasing the tempering level (temperature difference 6) requires increasing the preheating temperature, which makes the glass too soft and, as a result, the glass can be damaged by quenching air flow. In the process of the instant disclosure, the glass sheet is harder due to the lower surface temperature and, as a result, the roller marks are not formed on the glass.

For glass less than 3 mm thick (for example for 2.6 mm) the temperature difference 6 in the related art may only reach about 80° C., which is not enough for tempering. In present disclosure, the temperature difference 6 can be very high (e.g., 110° C.). so as to provide an appropriate tempering level. The great temperature difference 6 of the instant disclosure is achievable because the mid-plane temperature 4 and the surface temperature 5 can be separately controlled by focusing the microwave energy on the mid-plane so as to not substantially affect the surface temperature 5. The comparatively low surfaces temperature provides higher stiffness of the glass sheet that allows the quench air pressure to be increased thereby result in a higher tempering level than that of the related art.

The most preferable microwave frequency range for the present disclosure is when the incident microwave wavelength λ, in the glass being heated (λ=c₁/f, where c₁ is speed of light in a vacuum) is selected in a glass thickness range that allows an increase in the efficiency of the applied microwave radiation of at least 3 to 5 times. When the thickness of a glass sheet is commensurate with the wavelength of the incident microwave radiation inside the material, a standing wave distribution of microwave power is formed.

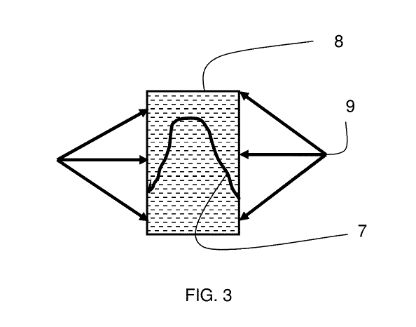

As illustrated in FIG. 3, the distribution of the microwave energy/heat 7 in a glass sheet 8 when a frequency of the microwave beam 9 corresponds to a wavelength, which is in the glass and about two times the thickness of the glass being heated. In this case the microwave generated standing wave appears to be inside of the glass sheet increasing primary heating of the mid-plane and efficiency of using microwave radiation.

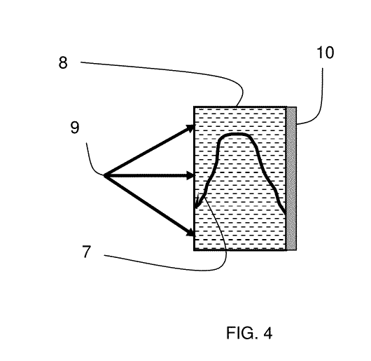

In the exemplary embodiments of the present disclosure discussed above the beam of the electromagnetic radiation may be applied from both sides simultaneously or from any one side. In a case where the glass being tempered is low-e coated, the microwave beam is applied from the uncoated side. Referring to FIG. 4, the low-e coating 10 can be used as an reflector to create a standing wave inside of the glass 8 to, as mentioned above, increasing primary heating of the mid-plane and efficiency of using microwave radiation. This effect can be intensified if frequency of the beam 9 also corresponds to a wavelength, which is in the glass and about two times the thickness of the glass being heated. Since the low-e coating 10 only absorbs a very tiny amount of the microwave frequency and the surface temperature of the glass is kept low, damage to the low-e coating is prevented.

### Exemplary and Electromagnetic Irradiation Set-Up

The foregoing exemplary embodiments and advantages are merely exemplary and are not to be construed as limiting the present inventive concept. The description of the exemplary embodiments is intended to be illustrative, and not to limit the scope of the claims, and many alternatives, modifications, and variations will be apparent to those skilled in the art.

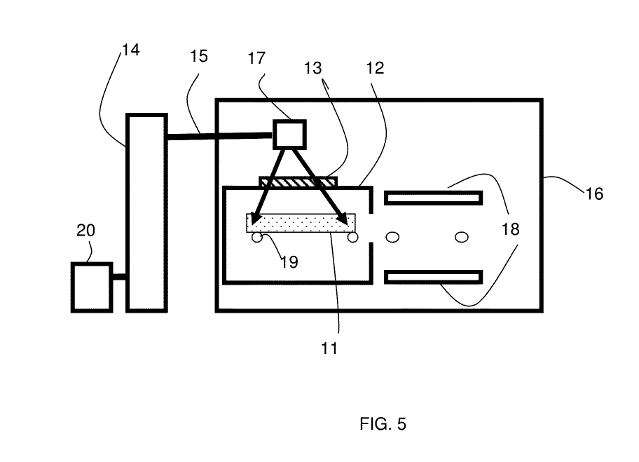

FIG. 5 shows an apparatus for thermally tempering glass. The apparatus includes a controller 20 for setting a microwave frequency of a beam 15 according to a thickness of the glass 11, a heating section (e.g., radiant heat oven 12) that exposes the glass 11 to the beam of microwave radiation in order to heat a non-surface portion the glass sheet to above a softening point without causing a surface temperature of the glass to raise above the softening point, a quenching section that includes quench nozzles 18 and quenches the glass, and

a transferring unit (e.g., rollers 19) that transfer the glass from the heating section to the quenching section.

The beam 15 may be applied to the glass before and during the quenching of the glass 11. That is, the mid-plane of the glass 11 may be heated by the beam while the surface of the glass 11 is quenched by the quench nozzles 18.

The present inventors chose a 50 mm by 50 mm, 3 mm thick soda-lime glass plate 11 for tempering. The strain point and the softening point of soda-lime glass are about 510° C. and 720° C., respectively. A conventional radiant heat oven 12 with a microwave transparent cover 13 was chosen for preheating. However, it is understood that other forms of preheating are available.

A microwave generator gyrotron 14 was chosen as a tool for microwave processing. The gyrotron 14 generated a microwave beam 15 with a frequency of 84 GHz and up to 20 kW power. This microwave beam 15 was directed into microwave processing chamber 16. A mirror system 17 was built to transform the initial microwave beam 15 into uniform spot with a 70 mm diameter. The mirror system 17 directed the beam onto the surface of the glass plate 11.

The preheating oven 12 contained the glass plate 11 and was placed inside microwave processing chamber 16. The glass plate 11 was preheated from room temperature to 550° C. within 20 minutes to insure uniform preheating. Then, the microwave beam 15 was switched on to continue processing the glass plate 11 in a controllable thermal environment. The total microwave power for processing was set to 8 kW, which provided a microwave power density of around 140 watts per square centimeter. The temperature of the glass plate surface was measured by pyrometer (not shown). When surface temperature reached 580° C., the microwave processing stopped and glass plate 11 moved to the quench nozzles 18 where the glass plate 11 rapidly cooled down by pressurized air from gas cylinders (not shown).

Tempering level of the processed glass plate was evaluated and estimated to have a surface compression (or bending strength) of over 130 Mega Pascals (MPa), which is significantly higher than the tempering level that is achievable by the related art. Indeed, the stress level for thin glass (i.e., less than 3 mm) can be dramatically increased when compared to the related art. Also, when compared to the related art, glass that is tempered according to the present disclosure higher a greater quality and is more flat. In addition, the instant Application permits glass with a low-e coating to be tempered.

Unless specifically stated or obvious from context, as used herein, relative terms such as “about,” “substantially,” etc., are understood as within a range of normal tolerance in the art, for example within 2 standard deviations of the mean. These relative terms can be understood as within 10%, 9%, 8%, 7%, 6%, 5%, 4%, 3%, 2%, 1%, 0.5%, 0.1%, 0.05%, or 0.01% of the stated value.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described components in the described system, architecture, or device are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of thermally tempering a glass sheet, the method comprising:
preheating the glass sheet to a temperature higher a strain point of the glass sheet and lower than a softening point of the glass sheet;
exposing the glass sheet to a beam of penetrating microwave radiation in order to heat the mid-plane of the glass sheet to a temperature that is above the softening point while simultaneously keeping a surface of the glass sheet at a temperature that is below the softening point; and
quenching the glass sheet so that the temperature of the mid-plane and the surface of the glass sheet fall below the strain point, respectively.

2. The method of claim 1, further comprising applying the beam of microwave radiation to at least one surface of the glass sheet.

3. The method of claim 1, further comprising scanning the beam of microwave radiation over an entirety of at least one surface of the glass sheet.

4. The method of claim 1, further comprising selecting a wavelength of the microwave radiation to provide a radiation penetration depth that is equal to 0.5 to 5 times a thickness of the glass sheet.

5. The method of claim 1, further comprising selecting a frequency of the microwave radiation to be between about 10 GHz to about 200 GHz.

6. The method of claim 5, wherein the frequency of the microwave radiation is selected to correspond to a thickness of the glass sheet.

7. The method of claim 1, further comprising selecting a wavelength of the microwave radiation to be approximately two times a thickness of the glass sheet.

8. The method of claim 1, further comprising supplying the microwave beam radiation from a gyrotron.

9. The method of claim 1, wherein the glass sheet has a low-e coating on one surface, the method further comprising applying the beam of microwave radiation from the other surface of the glass sheet.

10. The method of claim 1, further comprising quenching the glass sheet while the mid-plane of the glass sheet is heated by the microwave.

11. The method of claim 1, further comprising transferring the glass sheet to the quench using rollers while the mid-plane of the glass sheet is above the softening point.

12. The method of claim 11, wherein during the thermal tempering a temperature of the mid-plane of the glass sheet is above the softening point and the surface of the glass sheet is below the softening point.

13. The method of claim 1, wherein the glass sheet has a coated surface that reflects radiant infrared energy and an uncoated surface, the method further comprising directing the beam of microwave radiation into the uncoated surface.

14. The method of claim 1, wherein the glass sheet is made from any type of glass or glass-like material the density of which changes suddenly with temperature.

15. The method of claim 1, wherein a temperature of the surface of the glass sheet is substantially unaffected by exposing the glass sheet to the beam of penetrating microwave radiation.

16. A method of thermally tempering glass, the method comprising:
exposing the glass to microwave radiation in order to heat a non-surface portion the glass sheet to above a softening point while simultaneously keeping a surface temperature of the glass below the softening point; and
quenching the glass so that the non-surface portion and the surface of the glass both fall below a strain point.

17. An apparatus for thermally tempering glass, the apparatus comprising:
a controller for setting a frequency of a beam of microwave frequency according to a thickness of the glass;
a heating section that exposes the glass to the beam of microwave radiation in order to heat a non-surface portion the glass sheet to above a softening point without causing a surface temperature of the glass to raise above the softening point;
a quenching section that quenches the glass; and
a transferring unit that transfers the glass from the heating section to the quenching section.
